(19) United States
(12) Patent Application Publication
(10) Pub. No.: US 2018/0192684 A1
(43) Pub. Date: Jul. 12, 2018

(54) FOOD COMPRESSING DEVICES AND METHODS TO USE THE SAME

(71) Applicant: Taylor Precision Products, Inc., Seattle, WA (US)

(72) Inventors: Jason Liang, Seattle, WA (US); Janet Ryun, Oakland, CA (US)

(21) Appl. No.: 15/866,311

(22) Filed: Jan. 9, 2018

Related U.S. Application Data
(60) Provisional application No. 62/444,224, filed on Jan. 9, 2017.

(51) Int. Cl. A23N 1/02; B30B 9/02; B30B 15/00

(52) U.S. Cl. CPC A23N 1/02; B30B 15/0023; B30B 9/02

(57) ABSTRACT

A food processing tool for extracting a consumable food product from a food item can include a first reamer having an outer surface, with the food item positioned on the first reamer, and a second reamer having an interior surface. The food processing tool can also include a drive mechanism fixedly coupled to the second reamer, where the drive mechanism can move the second reamer toward the first reamer so that the interior surface of the second reamer contacts the food item to compress the food item. The compression of the food item can alter a shape of the food item to a substantially flat shape and produce the consumable food product. The food processing tool can also include a receptacle sized and shaped to receive the consumable food product. Related methods for using the food processing tool are also provided.

### BACKGROUND

### Technical Field

The present disclosure is generally related to kitchen tools. In particular, the present disclosure relates to tools for squeezing, pressing, extruding or otherwise processing food articles.

### Description of the Related Art

Hand-held or, more generally, manually operated juicers, garlic presses, and the like are generally known in the kitchen product market. The traditional devices of this nature may typically include some form of a cone structure that protrudes outwardly from a center thereof, or in some instances can include cavities to place the food item therein. A pressure is applied to the food item to extract juices from such food items. The pressure in such traditional devices can be applied manually by a user by pressing on a member which compresses the food item, or in some instances, via an arm that is hinged and rotatable to apply pressure to the food item to extract juices therefrom. In such traditional devices, it is generally difficult to apply pressure uniformly over the food item due, for example, to the complex, compound surfaces of the cone structure. Further, a volume of the extracted juices is typically limited and it often becomes difficult to extract the juices in a controlled manner due to the difficulty in flattening the food item in such traditional devices. Still further, in some instances, manually applying pressure to compress the food items can commonly require use of both hands to apply sufficient forces to extract sufficient volume of juices. Still further, the hinged connections generally require a longer travel path for the arm that contacts the food item, which can limit or reduce the compactness of such devices.

### BRIEF SUMMARY

In various implementations described herein, food processing tools and related methods to use the same with robust, compact, and efficient form factors enable extracting consumable food products from food products in a controlled manner. In one example, non-limiting implementation, a food processing tool for extracting a consumable food product from a food item can be summarized as including a first reamer having an outer surface adapted such that the food item can be positioned on the first reamer during use, a second reamer having an interior surface, and a drive mechanism fixedly coupled to the second reamer. The drive mechanism can be actuable to move the second reamer toward the first reamer so that the interior surface of the second reamer contacts the food item to compress the food item, the compression altering a shape of the food item to a substantially flat shape and producing the consumable food product. The food processing tool can also include a receptacle sized and shaped to receive the consumable food product.

In another example, non-limiting implementation, a method for extracting a consumable food product from a food item using a food processing tool having a first reamer, a second reamer, a drive mechanism, and a receptacle can be summarized as including providing a substantially semi-spherical portion from the food item and positioning the semi-spherical portion on the first reamer of the food processing tool. The method can further include moving the second reamer toward the first reamer via the drive mechanism and compressing the semi-spherical portion to extract juices therefrom.

### BRIEF DESCRIPTION OF THE SEVERAL VIEWS OF THE DRAWINGS

FIG. 1 is a perspective view of a food processing tool, according to one example implementation.

FIG. 2 is an exploded view of the food processing tool of FIG. 1.

FIG. 3 is a cross-sectional view of the food processing tool of FIG. 1, taken along lines 3-3.

FIG. 4 is a cross-sectional view of the food processing tool of FIG. 1, taken along lines 4-4.

FIG. 5 is a perspective view of the food processing tool of FIG. 1 illustrating the food processing tool in a withdraw configuration pre-compression.

FIG. 6 is a perspective of the food processing tool of FIG. 1 illustrating the food processing tool in a compress configuration.

FIG. 7 is a perspective of the food processing tool of FIG. 1, illustrating the food processing tool in a withdraw configuration post-compression.

### DETAILED DESCRIPTION

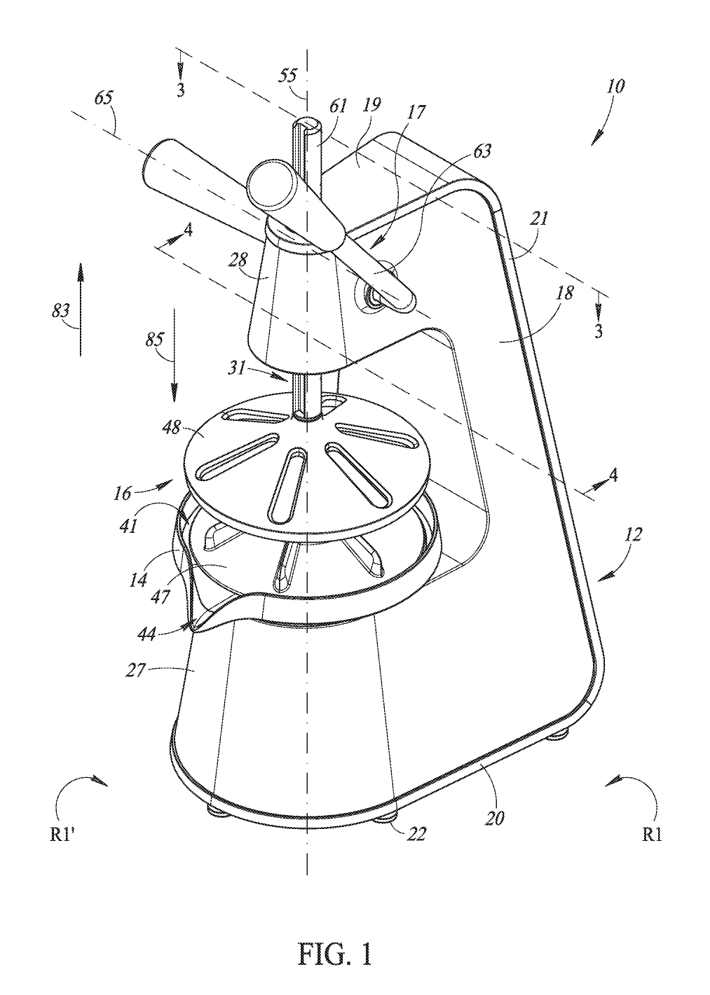

The present detailed description is generally directed to a device or a tool for processing food items. Many specific details of certain example implementations and designs are set forth in the following description and in FIGS. 1-7 to provide a thorough understanding of such implementations. One skilled in the art, however, will understand that the disclosed implementations may be practiced without one or more of the details described in the following description. Additionally, the tools or devices are discussed in the context of preparing food items because they have particular utility in this context. For example, the tools or devices are particularly well suited for squeezing, pressing, dispensing, crushing, metering, or, more generally, for compressing a food item to process or deliver consumable food products.

It should be noted that, as used in this specification and the appended claims, the singular forms “a,” “an,” and “the” include plural referents unless the context clearly dictates otherwise. For example, a lever may include a single lever or a plurality of levers. It should also be noted that the term “or” is generally employed in its sense including “and/or” unless the content clearly dictates otherwise.

FIGS. 1-4 illustrate a food processing tool 10 according to one example implementation that can process a food item and dispense a consumable food product. The food processing tool 10 generally can compress a food item to extract a consumable food product therefrom, for example, in a form of a liquid, and dispense the extracted food product to a container, for example, a jug, pitcher, etc., which have not been shown for ease of description and clarity. The food processing tool 10 is generally sized, shaped, or designed to flatten a food item, for example, a citrus fruit processed in a semi-hemispherical form, and extract juices therefrom in a controlled manner. While the implementations may be described herein in the context of a semi-hemispherical food item, it should be understood that other food items having different shapes and forms can also be processed using the various implementations of the food processing tools 10 described herein. For example, in some implementations, the food processing tool 10 can be used to process food items in hemispherical or other shapes and forms, such as garlic, nuts, potatoes, etc. Moreover, the extracts from such processed food items may be in liquid or solid forms. For instance, the food item, post-processing, may be compressed or crushed to a flat shape. As such, the use of the food processing tool 10 should not be construed or interpreted to any particular food item of a specific shape or form.

The food processing tool 10 includes a housing 12, a receptacle 14, a compress assembly 16, and a drive mechanism 17. The housing 12 includes a main body 18, a top panel 19, a lower panel 20, and a back panel 21. The lower panel 20 is coupled to a lower side of the main body 18 and includes a plurality of grip feet 22 which extend or protrude outwardly from a lower surface of the lower panel 20. The grip feet 22 are generally sized and shaped to rest on a working surface, for example, a table top, so that the food processing tool 10 can be stabilized during operation. In some implementations, the grip feet 22 can comprise elastomers, rubbers, or other suitable material that provides sufficient gripping ability. The back panel 21 is coupled to a back side of the main body 18, and the top panel 19 is coupled to a top side of the main body 18. The top panel 19 is coupled to the back panel 21 and includes a top panel drive shaft aperture 23 and a top panel guide lip 24 extending inwardly toward a center of the top panel drive shaft aperture 23. The lower panel 20 is coupled to the back panel 21, so that the top panel 19, back panel 21, lower panel 20, and the main body 18 form an enclosed structure. In some implementations, the lower panel 20, the top panel 19, and the back panel 21 can be coupled to the main body 18 via fasteners, welding, adhering, or similar structures. In other implementations, the housing 12 can be formed as an integral unit. The housing 12 and components thereof can comprise metal, plastics, combinations thereof, or the like. The housing 12 and the components thereof, whether individually or as an integral, monolithic unit, can be formed via a machining process, molding process (e.g., injection molding process, compression molding process, etc.).

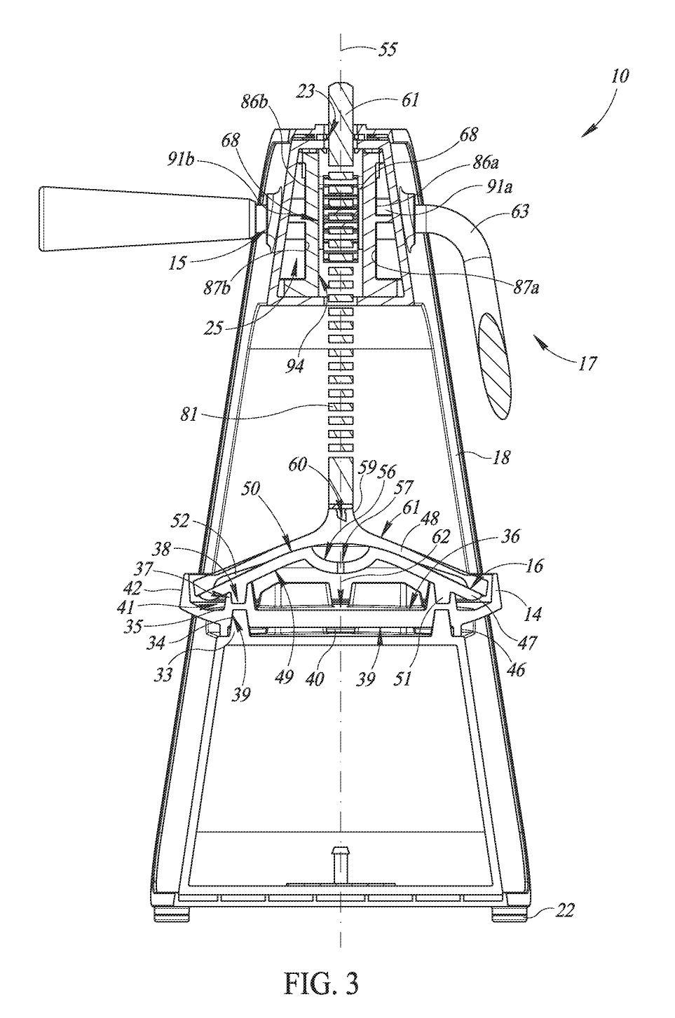

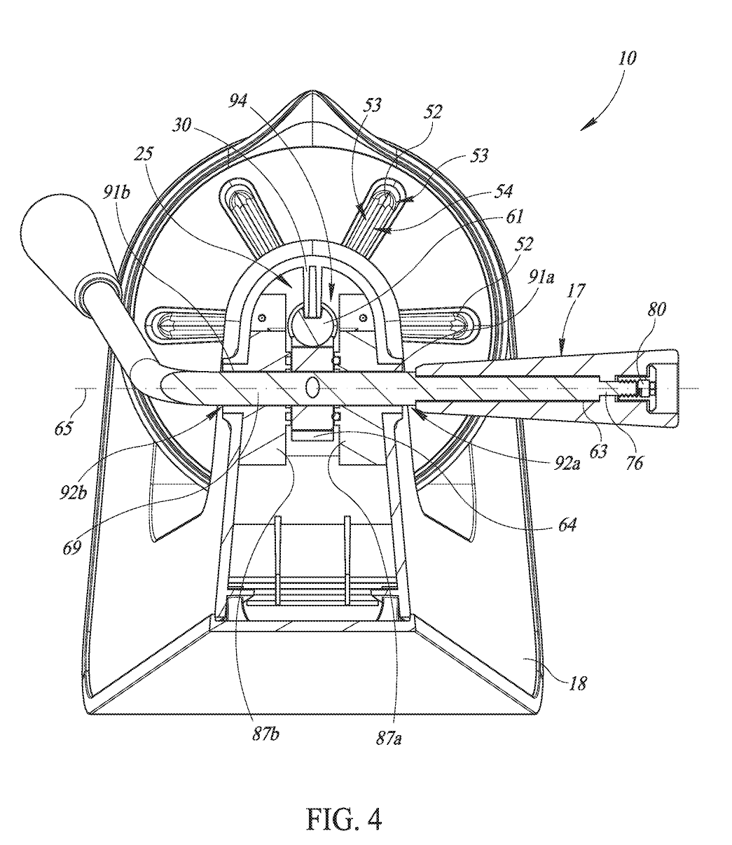

The main body 18 is generally hollow to define an interior region 25 which is sized and shaped to receive or house one or more components of the drive mechanism 17, as illustrated in FIGS. 3 and 4, and described in more detail below. The main body 18 includes an opening 26 between a lower portion 27 of the main body 18 and an upper portion 28 of the main body 18. The upper portion 28 of the main body 18 includes a drive shaft aperture 29 and a guide lip 30 extending inwardly toward a center of the drive shaft aperture 29. The upper portion 28 also includes a lever aperture 15 that extends through the upper portion 28 of the main body 18.

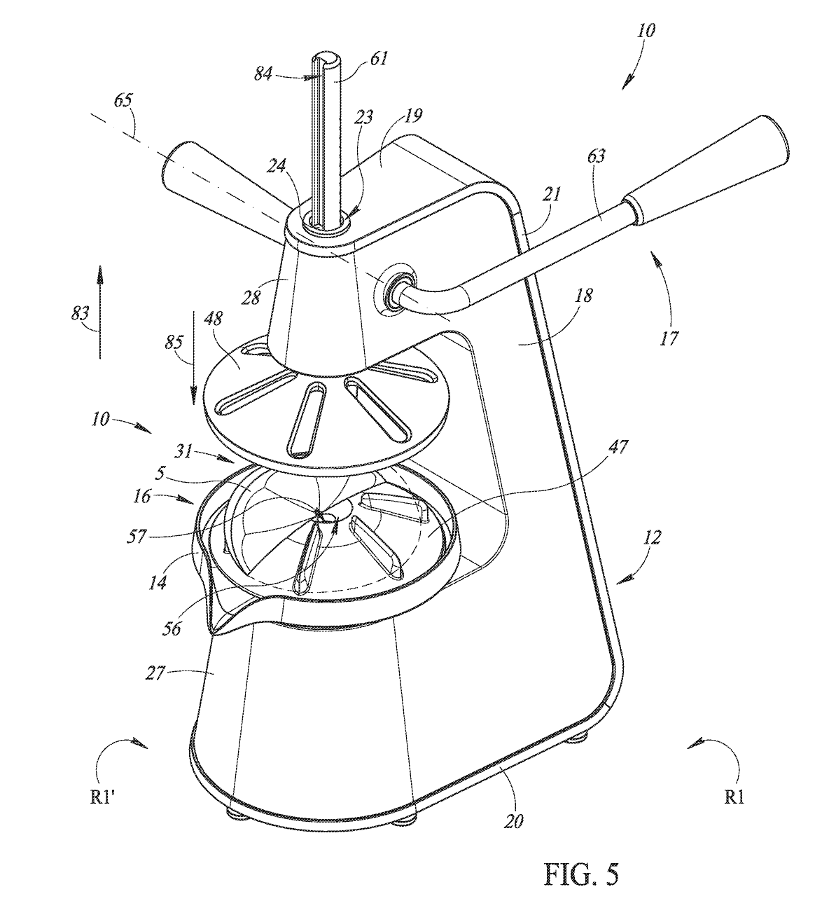

The opening 26 generally defines a working region 31 in which a food item, for example, a semi-hemispherical orange 5 (FIG. 5) is positioned and processed as described in further detail below. In particular, the opening 26 defines an upper surface 32 of the lower portion 27 of the main body 18. The upper surface 32 includes a plurality of tab elements 33 which protrude outwardly from the upper surface 32. The tab elements 33 are angularly spaced apart about a center of the upper surface 32. Each tab element 33 is sized and shaped to be coupleably received by the receptacle 14. In particular, each tab element 33 includes an outer wall portion 34 that tapers inwardly so that the tab element 33 can be tautly received in the receptacle 14.

The receptacle 14 includes a plurality of coupling members 35 which protrude outwardly from an interior surface 36 of the receptacle 14. Each coupling member 35 includes a peripheral wall portion 37 that surrounds a first recess 38. The first recess 38 is sized and shaped to coupleably receive the compress assembly 16, or more specifically, one or more portions thereof. An exterior surface of the receptacle 14 includes a second recess 39 which extends through a base portion 40 of the receptacle 14 toward the corresponding coupling member 35, which generally defines an H-shaped structure of the coupling members 35. The second recess 39 is sized and shaped to coupleably receive the corresponding tab element 33 of the lower portion 27 of the main body 18. The second recess 39 can be sized and shaped to have an area that is equal to or slightly less than the outer wall portion 34 of the corresponding tab element 33. In particular, as described above, the outer wall portion 34 of the corresponding tab element 33 tapers inwardly. Accordingly, as the tab element 33 is inserted into the corresponding second recess 39, frictional forces can tautly or rigidly couple the tab element 33 to the receptacle 14 via the second recess 39.

Adjacent to the coupling members 35, the receptacle 14 includes a collection region 41 which tapers upwardly from the interior surface 36 into an upper receptacle wall 42. The upper receptacle wall 42 is sized and shaped to surround the compress assembly 16 and defines an outer periphery of the receptacle 14, which directs or leads to a dispense region 44, e.g., a spout, to provide an exit area for the food extract. In particular, the collection region 41 is sized and shaped to collect processed food items, e.g., liquids such as juice extracts, and the tapered shape facilitates directing the collected processed food items to flow or move toward the dispense region 44. As illustrated in FIG. 3, for example, at a bottom side, the receptacle 14 also includes a lower flange portion 46. The lower flange portion 46 is sized and shaped to surround the angularly spaced apart tab elements 33 of the lower portion 27 of the main body 18, when the housing 12 is coupled to the receptacle 14.

In some implementations, the receptacle 14 can comprise metal, plastics, combinations thereof, or the like. Each component or portion of the receptacle 14 can be individually coupled to the other components, or the receptacle 14 can be formed as an integral, monolithic unit. In some implementations, the receptacle 14 or the components thereof, whether individually or as an integral, monolithic unit, can be formed via a machining process, molding process (e.g., injection molding process, compression molding process, etc.).

With continued reference to FIGS. 1-4 and as illustrated in FIG. 3 and described above, the first recess 38 of each coupling member 35 is sized and shaped to coupleably receive the compress assembly 16. In particular, the compress assembly 16 includes a first reamer 47 and a second reamer 48. In some implementations, the first reamer 47 has a generally frusto-conical shape having a lower surface 49 and an upper surface 50. More generally, the first reamer 47 is sized and shaped to receive and/or contact a wide variety of food products, such as fruits of varying sized and shapes, e.g., limes, lemons, oranges, and relatively small grapefruits. Protruding outwardly from the lower surface 49, the first reamer 47 includes a plurality of first reamer tab elements 51. The first reamer tab elements 51 are sized and shaped to be coupleably received by the first recess 38 of the corresponding coupling member 35. Again, in some implementations, the first reamer tab elements 51 can be sized and shaped so that an outer wall portion of the first reamer tab element 51 tapers inwardly so that, when received by the corresponding first recess 38 of the coupling member 35, frictional forces can tautly or rigidly couple the first reamer tab element 51 to the receptacle 14 via the first recess 38 of the coupling member 35.

The first reamer 47 includes a plurality of press elements 52 that protrude outwardly from the upper surface 50 of the first reamer 47 and are angularly spaced apart relative to a center of the first reamer 47. Each press element 52 includes a pair of side surfaces 53 which taper inwardly toward each other to define a press surface 54. At or proximate to a central axis 55, the first reamer 47 includes a neck down region 56 that surrounds a central reamer aperture 57. The neck down region 56 is generally sized and shaped to receive a center of a food item, for example, a semi-hemispherical food item, such as a citrus fruit, e.g., orange, lemon, etc. In particular, the neck down region 56 allows or permits the food item to be positioned in or near the neck down region 56, so that when pressure is applied during use or operation, the center of the food item can deflect in or toward the neck down region 56 to allow the food item to be transformed or altered to a flattened state or shape, with the upper surface 50 guiding the food item as it transforms or alters from a semi-hemispherical shape to a flatter state or shape.

Moreover, the press elements 52 can be sized and shaped to facilitate the transformation or alteration of the food item to the flatter state or shape and increase consistency and volume of the extracted food item, for example, juices or liquids, more generally. For example, in implementations where a semi-hemispherical food item is positioned on the first reamer 47, the press elements 52 can be sized, shaped, and/or positioned to penetrate a pulp region of the food item. Thus, as pressure is applied to the food item, the penetration of the press elements 52 via the relatively sharp press surfaces 54 can facilitate flattening the food item and breaching a juice sac of the food item to extract juices therefrom at an increased volume and in a controlled manner by, for example, partitioning the food item into a plurality of sections.

In some implementations, the central reamer aperture 57 can also be sized and shaped to provide a flow path 62 for the extract of the food item to the receptacle 14 during operation, for example, a liquid extracted from the food item can flow to the receptacle 14 via the flow path 62, such flow path 62 being in addition to the flow path provided by the upper surface 50 of the first reamer 47 which guides the extract from the food item toward the collection region 41 of the receptacle 14.

In some implementations, the first reamer 47 can comprise metal, plastics, combinations thereof, or the like. In some implementations, the first reamer 47 can be designed to be rigid. In other implementations, the first reamer 47 can be designed to be elastic or resilient, deformable or conformable which enables the first reamer 47 to deform or alter its shape as pressure is applied to the first reamer 47. Again, each component of portion of the first reamer 47 can be individually coupled to the other components, or the first reamer 47 can be formed as an integral, monolithic unit. In some implementations, the first reamer 47 or the components thereof, whether individually or as an integral, monolithic unit, can be formed via a machining process, or a molding process (e.g., injection molding process, compression molding process, etc.).

The second reamer 48 is generally sized and shaped to receive and/or contact a wide variety of food products, such as fruits of varying sized and shapes, e.g., limes, lemons, oranges, and relatively small grapefruits. The second reamer 48 includes a plurality of slot regions 58 that extend through a body of the second reamer 48 and are angularly spaced apart relative to a center of the second reamer 48. At or near the center of the second reamer 48, a coupling flange 59 protrudes outwardly. The coupling flange 59 is sized and shaped to couple to the drive mechanism 17. In some implementations, the coupling flange 59 includes a shaft aperture 60 which extends therethrough. The shaft aperture 60 is sized and shaped to coupleably receive a drive shaft 61 of the drive mechanism 17. In particular, in some implementations, the shaft aperture 60 can include a plurality of threads to threadedly couple to the drive shaft 61. In other implementations, the coupling flange 59 can be coupled to the drive shaft 61 via fasteners, welding, adhering, etc. In either implementation, the second reamer 48 is fixedly coupled to the drive mechanism 17 to move therewith.

As illustrated in FIG. 1, for example, the slot regions 58 are sized and shaped to allow or permit the press elements 52 of the first reamer 47 to move toward the slot regions 58. In particular, as the coupling flange 59 is located at or near the center of the second reamer 48 and coupleably receives the drive mechanism 17, the second reamer 48 can apply pressure at or near a center of a food item, for example, the semi-hemispherical fruit discussed above, and positioned at or on the first reamer 47. Thus, as pressure is applied to the food item, the sandwiched food item can be compressed and altered from the semi-hem ispherical shape to a flatter state or shape, with the press elements 52 moving toward or through the slot regions 58 to extract the food item, for example, extracted juices, in the manner described above. Further, when no food item is sandwiched between the first and second reamers 47, 48, the slot regions 58 can allow the press elements 52 to penetrate through the slot regions 58 to improve compactness of the food processing tool 10, for example, when the food processing tool 10 is in a stored or non-use configuration.

In some implementations, the second reamer 48 can comprise metal, plastics, combinations thereof, or the like. In some implementations, the second reamer 48 can be designed to be rigid. In other implementations, second reamer 48 can be designed to be elastic or resilient, deformable or conformable that enables the second reamer 48 to deform or alter its shape as pressure is applied to the second reamer 48. Again, each component of portion of the second reamer 48 can be individually coupled to the other components, or the second reamer 48 can be formed as an integral, monolithic unit. In some implementations, the second reamer 48 or the components thereof, whether individually or as an integral, monolithic unit, can be formed via a machining process, molding process (e.g., injection molding process, compression molding process, etc.).

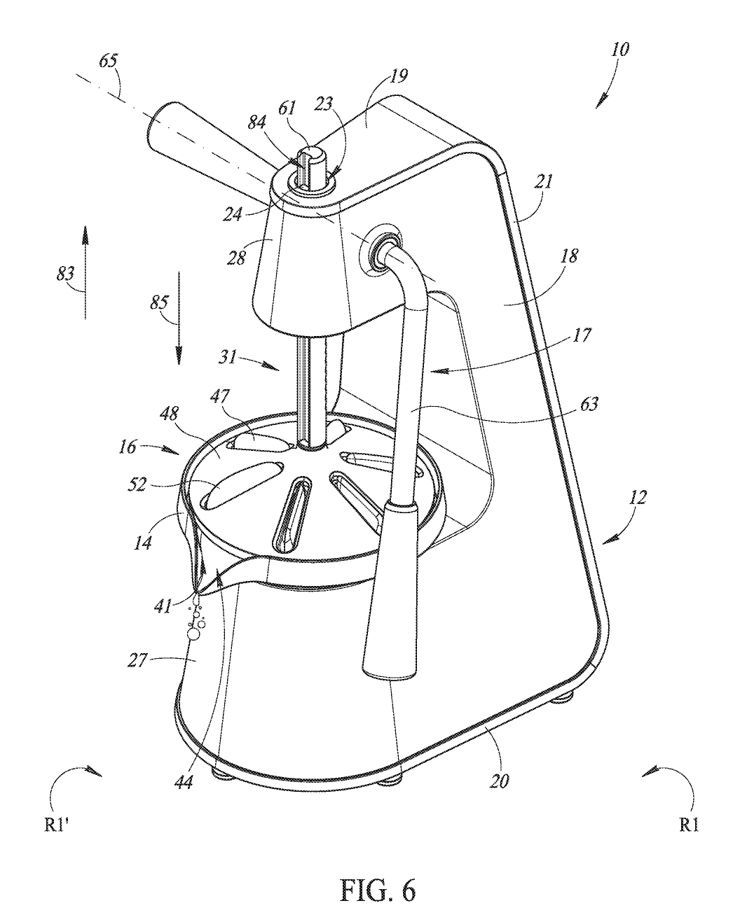

The drive mechanism 17 is generally configured to move the second reamer 48 so that the food processing tool 10 can move between a withdrawal configuration (FIG. 5) and a compress configuration (FIG. 6). The drive mechanism 17 includes a lever 63 rotatably coupled to a gear 64 and configured to rotate the gear 64 about an axis of rotation 65. The drive mechanism 17 also includes the drive shaft 61 that is pivotably coupled to the gear 64 such that pivotable or rotatable motion of the gear 64 is converted to linear or translational motion of the drive shaft 61 as described in more detail below.

The gear 64 includes a plurality of gear teeth 67 that project outwardly from a gear body 66 and are radially symmetric with respect to a central aperture 99 extending through the gear body 66 such that the gear 64 and the axis of rotation 65 are generally coaxial. The lever 63 is generally an L-shaped structure having a handle portion 68 and a support portion 69. The support portion 69 extends through the central aperture 99 disposed in the gear body 66, where the central aperture 99 is sized and shaped to fixedly couple the support portion 69 to the gear body 66 so that the gear body 66 can rotate with the lever 63. Proximate to an end of the lever 63, the handle portion 68 includes handle connection portion 70 which is sized and shaped to be arranged telescopically and be optionally coupleable to a handle 71. In some implementations, the handle 71 can have a cone shaped structure and include a handle aperture 72 which is sized and shaped to coupleably receive the handle connection portion 70. More generally, the handle 71 is fixedly coupled to the handle portion 68 to provide gripping ability to a user as the lever 63 is moved during operation or use. Proximate to another end of the lever 63, the support portion 69 includes a first support connection portion 76 and a second support connection portion 77. The first and second support connection portions 76, 77 are arranged to extend telescopically. The support portion 69 is sized and shaped to be optionally coupleable to a support 78. The support 78 includes a support connection aperture 79 which is sized and shaped to coupleably receive the first and second support connection portions 76, 77. In particular, the second support connection portion 77 is coupled to the support 78 via a fastener 80, e.g., a cap screw, which is configured to couple the support 78 to the support portion 69 in a manner such that the lever 63 can rotate independent of, or relative, to the support 78. Again, more generally, the support 78 can provide gripping ability to a user as the lever 63 is moved during operation or use. For example, a user can use one hand to rotate the lever 63 via the handle 71 and use the other hand to grip or hold the support 78 for support during operation or use.

As noted above, the gear 64 is sized and shaped to convert pivotable motion of the lever 63 into linear or translational motion of the drive shaft 61. In particular, the drive shaft 61 includes a plurality of drive gear teeth 81 that are disposed on a back side of the drive shaft 61. The drive gear teeth 81 are sized and shaped to operatively enmesh or engage with the gear teeth 67 of the gear 64. Thus, as the lever 63 is rotated in a counterclockwise direction indicated by arrow R1, the gear 64 rotates in the counterclockwise direction R1 and the gear teeth 67 of the gear 64 engage the drive gear teeth 81 to drive, move, or translate the drive shaft 61 in a direction indicated by arrow 85. By contrast, as the lever 63 is rotated in a clockwise direction indicated by arrow R1′, the gear 64 rotates in the clockwise direction R1′ and the gear teeth 67 of the gear 64 engage the drive gear teeth 81 of the drive shaft 61 to drive, move, or translate the drive shaft 61 in a direction indicated by arrow 83. At a front side, the drive shaft 61 includes a guide slot 84 which extends longitudinally along a substantial length of the drive shaft 61.

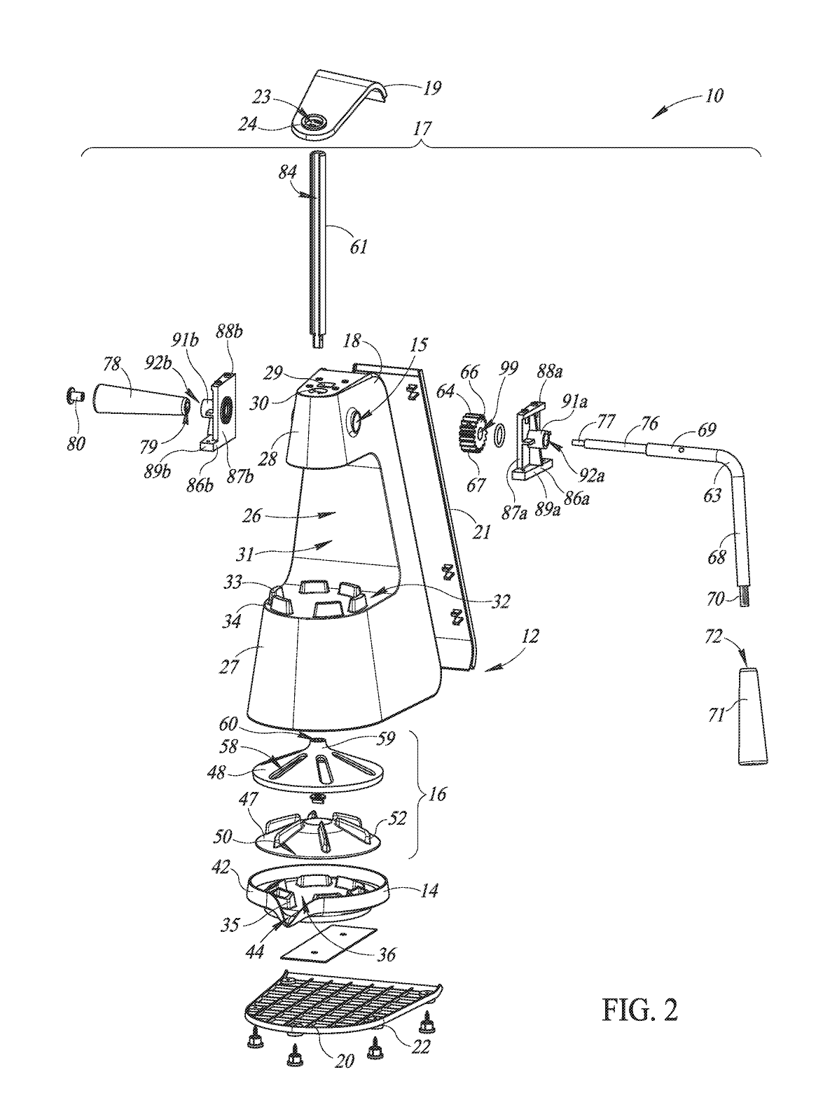

The drive mechanism 17 is at least partially supported by or mounted in the housing 12 via a pair of support brackets 86a, 86b that are mounted in the interior region 25 of the main body 18 of the housing 12. Each support bracket 86a, 86b has a generally E-shaped structure and includes corresponding webs 87a, 87b, upper flanges 88a, 88b, and lower flanges 89a, 89b. As illustrated in FIG. 2, each support bracket 86a, 86b is a mirror image of the other. Each upper flange 88a, 88b of each support bracket 86a, 86b is coupled to the top panel 19 via one or more fasteners and the lower flange 89a, 89b of each support bracket 86a, 86b is coupled to a portion of the upper portion 28 of the main body 18 via one or more fasteners. Protruding outwardly from each web 87a, 87b, each support bracket 86a, 86b includes a coupling flange 91a, 91b which includes corresponding coupling apertures 92a, 92b extending through the webs 87a, 87b. Each coupling aperture 92a, 92b is sized and shaped to receive the support portion 69 of the lever 63, which support portion 69 extends through the coupling apertures 92a, 92b and is optionally coupled to the support 78 as described in detail above. In particular, each coupling aperture 92a, 92b is sized and shaped to permit the lever 63 to rotate independently of, or relative to, the coupling flanges 91a, 91b of the support brackets 86a, 86b. Each coupling aperture 92a, 92b is sized and shaped to be substantially coaxial with the lever aperture 15 that extends through the upper portion 28 of the main body 18.

As illustrated in FIGS. 3 and 4, each support bracket 86a, 86b is coupled to the housing 12, as described above, and is spaced apart to define a drive mechanism region 94. In particular, the drive mechanism region 94 is sized and shaped in a manner such that the gear 64 is received between the webs 87a, 87b of the support brackets 86a, 86b. As the support portion 69 extends through the coupling flanges 91a, 91b of the support brackets 86a, 86b and the central aperture 99 of the gear 64, with the support brackets 86a, 86b coupled to the housing 12, the gear 64 and the lever 63 are supported by the housing 12.

The drive shaft 61 is also positioned in the drive mechanism region 94. In particular, a portion of the drive shaft 61 extends through the top panel drive shaft aperture 23 of the top panel 19 of the housing 12 and the drive shaft aperture 29 of the main body 18 of the housing 12. As such, the top panel drive shaft aperture 23 of the top panel 19 and the drive shaft aperture 29 of the main body 18 are sized and shaped to receive the drive shaft 61 and allow or permit translational movement therethrough. In particular, the top panel guide lip 24 of the top panel 19 and the guide lip 30 of the main body 18 are sized and shaped to extend into the guide slot 84 of the drive shaft 61. In this manner, the top panel guide lip 24 and the guide lip 30 can guide the drive shaft 61 as it translates between various positions, e.g., between withdrawal and compress configurations (FIGS. 5 and 6).

FIGS. 5 through 7 illustrate the food processing tool 10 in a withdrawal configuration prior to compression of a food item, a compress configuration, and a withdrawal configuration after compression of the food item, respectively. The food processing tool 10 can be configured to be in the withdrawal configuration by rotating the lever 63 in the clockwise direction RI, which can rotate the gear 64 to convert pivotable or rotational movement thereof to linearly or translationally move the drive shaft 61 in the direction indicated by arrow 83 toward the upper portion 28 of the main body 18. Again, the linear or translational movement of the drive shaft 61 is guided via the extension of the top panel guide lip 24 of the top panel 19 and the guide lip 30 of the main body 18 being inserted in the guide slot 84 disposed in the drive shaft 61.

As described in more detail above, the drive shaft 61 is fixedly coupled to the first reamer 47, movement of which toward the upper portion 28 of the main body 18 exposes second reamer 48 to receive the food item, for example, an exemplary semi-hemispherical orange 5 illustrated in FIG. 5 in partial cutaway. As such, the working region 31 of the food processing tool 10 becomes accessible to a user. As illustrated in FIG. 5, in the withdrawal configuration, the food item, e.g., the semi-hemispherical orange 5, is positioned on the second reamer 48 with a center portion of the semi-hemispherical orange 5 received in or around the neck down region 56 and a center of the semi-hemispherical orange 5 substantially aligned with the central reamer aperture 57.

As the lever 63 is rotated in the counterclockwise direction R1, for example, the lever 63 rotates the gear 64, which rotation can cause the gear 64 to convert pivotable or rotational movement thereof to linearly or translationally move the drive shaft 61 in the direction indicated by arrow 85 toward the lower portion 27 of the main body 18, so that the food processing tool 10 can move from the withdrawal configuration illustrated in FIG. 5 to the compress configuration illustrated in FIG. 6. As the drive shaft 61 moves in this manner, the fixedly coupled first reamer 47 moves toward the second reamer 48 and applies pressure to the sandwiched semi-hemispherical orange 5, or more generally, compresses the semi-hemispherical orange 5. Such compression caused by the drive mechanism 17 and, more specifically, by the first and second reamers 47, 48, can alter or transform the semi-hemispherical orange 5 to a flatter state or shape. Such alteration or transformation can advantageously allow for more extraction of extracts from the food item, for example, juices from the semi-hemispherical orange 5, and can also avoid or limit uncontrolled spilling over of the extracts to the working surface, such as a table top. Moreover, as the press elements 52 penetrate the pulp region of the semi-hemispherical orange 5, the juice sac of the semi-hemispherical orange 5 is sufficiently breached to increase the volume of the extracted juices in a controlled manner. As illustrated in FIG. 6, the extract or juices of from the semi-hemispherical orange 5 flow to the collection region 41 of the receptacle 14 and can be dispensed from the dispense region 44.

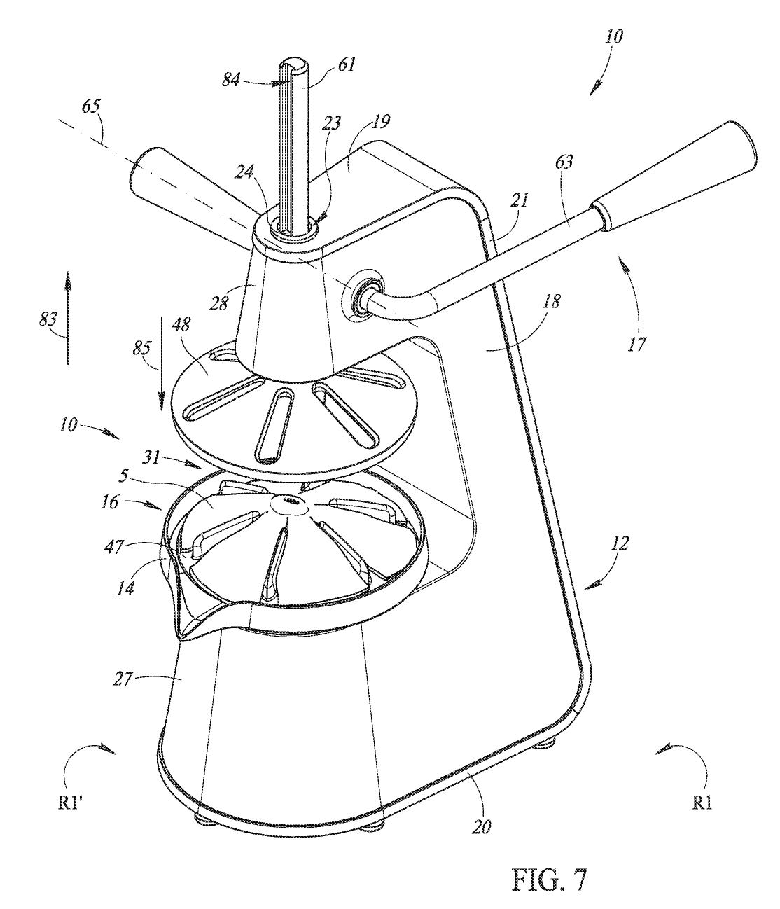

FIG. 7 illustrates the food processing tool 10 in a withdrawal configuration after the semi-hemispherical orange 5 has been compressed, as illustrated and described with respect to FIG. 6. Again, a user can rotate the lever 63 in the clockwise direction R1′ to cause the drive shaft 61 and the fixedly coupled first reamer 47 to move toward the upper portion 28 of the main body 18 to expose the compressed semi-hemispherical orange 5 and provide access thereto. As illustrated in FIG. 7, the semi-hemispherical orange 5 has altered or transformed into a flatter state or shape after the compression illustrated in FIG. 6 and in the manner described above. Moreover, the press elements 52, upon penetration into the semi-hemispherical orange 5, partition the semi-hemispherical orange 5 into a plurality of sections. As described above, the penetration of the press elements 52 facilitate altering the semi-hemispherical orange 5 to a flatter state or shape and breaching a juice sac of the semi-hemispherical orange 5 to extract juices therefrom at an increased volume and in a controlled manner.

Again, while the implementation of the food processing tool 10 is discussed and described above with respective to a semi-hemispherical orange 5, other food items, such as garlic, lemons, nuts, etc., are within the scope of the disclosed subject matter, irrespective of whether the food extract is in a liquid form or not. Moreover, the various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A food processing tool for use in extracting a consumable food product from a food item, the food processing tool comprising:
a first reamer having an outer surface adapted such that the food item can be positioned on the first reamer during use;
a second reamer having an interior surface;
a drive mechanism fixedly coupled to the second reamer, the drive mechanism actuable to move the second reamer toward the first reamer so that the interior surface of the second reamer can contact the food item when positioned on the first reamer to compress the food item, the compression capable of altering a shape of the food item to a substantially flat shape to extract the consumable food product from the food item; and
a receptacle sized and shaped to receive the consumable food product.

2. The food processing tool of claim 1 wherein the first reamer includes a plurality of press elements that protrude outwardly from the outer surface, the press elements adapted to at least partially penetrating the food item when the food item is positioned on the first reamer and the second reamer is moved toward the first reamer.

3. The food processing tool of claim 2 wherein the plurality of press elements are angularly spaced apart relative to a center of the first reamer.

4. The food processing tool of claim 1 wherein a center of the food item can be aligned with a center of the first reamer.

5. The food processing tool of claim 4 wherein the first reamer includes a necked down region sized and shaped to receive at least a portion of the food item when the food item is compressed via the second reamer.

6. The food processing tool of claim 1 wherein the drive mechanism includes:
a gear;
a lever rotatably coupled to the gear; and
a drive shaft rotatably coupled to the gear, rotation of the lever causing translational movement of the drive shaft toward the first reamer.

7. The food processing tool of claim 6, further comprising:
a housing having a drive shaft aperture which is sized and shaped to moveably receive therethrough the drive shaft.

8. The food processing tool of claim 7 wherein the drive shaft includes a guide slot and the housing includes a guide lip, the guide slot sized and shaped to moveably receive the guide lip.

9. The food processing tool of claim 6, further comprising:
a housing which includes an interior region sized and shaped to receive the gear, the housing including a lever aperture which is sized and shaped to receive therethrough a portion of the lever.

10. The food processing tool of claim 9, further comprising:
a pair of support brackets coupled to the housing, the pair of support brackets spaced apart to define a drive mechanism region, the gear coupled to the pair of support brackets and positioned in the drive mechanism region.

11. The food processing tool of claim 6 wherein the gear includes a plurality of gear teeth and the drive shaft includes a plurality of drive shaft gear teeth disposed on a backside thereof, the gear teeth of the gear and the drive shaft gear teeth of the drive shaft sized and shaped to engage each other.

12. A method for extracting a consumable food product from a food item using a food processing tool having a first reamer, a second reamer, a drive mechanism, and a receptacle, the method comprising:
providing a substantially semi-spherical portion from the food item;
positioning the semi-spherical portion on the first reamer of the food processing tool;
moving the second reamer toward the first reamer via the drive mechanism; and
compressing the semi-spherical portion to extract juices therefrom.

13. The method of claim 12 wherein moving the second reamer toward the first reamer via the drive mechanism includes rotating a lever of the drive mechanism, the rotation causing linear movement of the second reamer toward the first reamer.

14. The method of claim 12 wherein compressing the semi-spherical portion to extract juices therefrom includes causing press elements of the first reamer to penetrate at least a portion of the semi-spherical portion.

15. The method of claim 12 wherein extracting juices from the semi-spherical portion includes applying pressure to the semi-spherical portion to alter a shape of the semi-spherical portion to a substantially flat shape.
